(19) United States
(12) Patent Application Publication
(10) Pub. No.: US 2023/0182541 A1
(43) Pub. Date: Jun. 15, 2023

(54) AIR-CONDITIONING SYSTEM

(71) Applicant: TRUMA GERAETETECHNIK GMBH & CO. KG, Putzbrunn (DE)

(72) Inventor: Eugen PRESLER, Putzbrunn (DE)

(21) Appl. No.: 17/997,072

(22) PCT Filed: Apr. 7, 2021
(86) PCT No.: PCT/EP2021/000037

§ 371 Date: Oct. 25, 2022

(30) Foreign Application Priority Data
May 13, 2020 (DE) 10 2020 002 861.6

(51) Int. Cl. B60H 1/32; B60H 1/00

(52) U.S. Cl. CPC B60H 1/3227; B60H 1/00364

(57) ABSTRACT

The invention relates to an air conditioning system (1) for the cooling of air, having a condenser heat exchanger (41), a condenser fan (40), and a housing (10). The condenser heat exchanger (41) transfers thermal energy of the air to be cooled to an external air. The housing (10) includes at least one air inlet (42) and an air outlet (43) for the external air. The condenser fan (40) conveys the external air into the housing (10) via the air inlet (42) and discharges it via the air outlet (43). The air outlet (43) is designed such that the external air continues to move in as straight a line as possible after leaving the air outlet (43).

### FIELD OF DISCLOSURE

The present disclosure relates to an air conditioning system for cooling a room. Preferably, this is an air conditioning system to be mounted on the roof of a vehicle (for example, a motorhome or a travel trailer).

### BACKGROUND

The principle of the production of refrigeration, on which air cooling is based, by means of a cooling circuit has long been known and is described, for example, in WO 2007/042065 A1. Such air conditioning systems usually have two fans and two heat exchangers: one fan and one associated heat exchanger belong to the evaporator, in which the air of the room to be cooled is cooled by interaction with the refrigerant. Another fan and an associated heat exchanger belong to the condenser, in which thermal energy of the refrigerant is transferred to the ambient air and thus dissipated.

Examples of the configuration of air conditioning systems that are fitted, e.g., on the roofs of buses can be found in U.S. Pat. Nos. 4,732,011 A, 5,562,411 A, 4,748,825 A, 3,528,607 A or 5,605,055. Air conditioning systems in general for motor vehicles are taught in DE 10 2009 028 522 B4, DE 10 2011 080 491 A1, US 2016/0161154 A1 or US 2017/0190236 A1. An air conditioning system for a truck, for example, is shown in DE 10 2008 005 539 A1. EP 2 527 173 A1, U.S. Pat. Nos. 4,641,502 and 4,672,818 each describe roof-mounted air conditioning units for a travel trailer or a motor home. An air conditioning system for rail vehicles is disclosed in WO 2013/037335 A1. An air conditioning system for electronic devices is shown in U.S. Pat. No. 7,478,541 B2.

It is therefore the object of the present disclosure to propose an air conditioning system having improved characteristics compared to the prior art.

### SUMMARY

The present disclosure achieves the object by an air conditioning system for the cooling of air, the air conditioning system including a condenser heat exchanger, a condenser fan, and a housing, wherein the condenser heat exchanger transfers thermal energy of the air to be cooled to an external air, wherein the housing includes at least one air inlet and an air outlet for the external air, wherein the condenser fan conveys the external air into the housing via the air inlet and discharges it via the air outlet, and wherein the air outlet is designed such that the external air continues to move in as straight a line as possible after leaving the air outlet.

The thermal energy of the air to be cooled is first transferred to the coolant and then to the external air. The external air here originates, e.g., from the environment around the room the air of which is to be cooled by the air conditioning system. If the air conditioning system is, for example, a so-called roof-mounted air conditioning system, which is installed, e.g., on the roof of a travel trailer or a motorhome, the air in the interior of the travel trailer or motorhome is cooled and the heat is transferred to the ambient air around the travel trailer or motorhome as thermal energy. For this energy transfer, the condenser heat exchanger and the condenser fan are provided. The condenser heat exchanger carries the refrigerant and allows interaction with the external air in that the external air is passed through the condenser heat exchanger, absorbing heat from the refrigerant. The condenser fan provides for the movement of the external air into the housing of the air conditioning system and, after interaction with the condenser heat exchanger, for the movement out of the housing again. The housing has at least one air outlet, which is configured such that the external air continues to move in as straight a line as possible after leaving the air outlet and thus also the housing. This is intended to make sure that the kinetic energy of the heated external air is made use of for as long a distance as possible away from the housing. This in turn is intended to prevent exactly the heated external air from being sucked back in by the air conditioning system. This increases the effective power.

One example embodiment provides that the housing has a plurality of air outlets, that the air outlets open on only one blow-out side of the housing, and that the air outlets open in a straight line and substantially parallel to each other. In this example embodiment, after passing through the condenser heat exchanger, the external air is directed out of the housing through a plurality of air outlets. Here, the air outlets are all configured such that the external air travels substantially only rectilinearly after leaving the air outlets. The air passages extend such that they open substantially parallel to each other. Therefore, the air streams passing through them are also each directed parallel to each other and away from the housing. This is also intended to prevent swirling and minimize the risk of heated external air being drawn in.

One example embodiment consists in that the air outlets commence radially around the condenser fan. The condenser fan has a substantially circular outer contour along which the blades of the fan carry the air outward. The air outlets start adjacent to this outer contour (or, depending on the configuration, in a plane offset therefrom).

One example embodiment provides that carrier components of the housing are located between the air outlets, and that the carrier components at least partially carry the condenser heat exchanger. In this example embodiment, the housing serves to stabilize the air conditioning system by having carrier components that are located between the air outlets and on which the condenser heat exchanger at least partially rests. Thus, there are sections between the air outlets that are designed to be sufficiently stable for this function. The carrier components also allow the air outlets to be made sufficiently narrow so that protection against reaching in is provided.

According to one example embodiment, it is provided that the air outlets are open at the bottom, and that the carrier components are configured such that, in the assembled state of the air conditioning system, a bottom of the air outlets materializes.

In one example embodiment, the housing has a plurality of air inlets, and the air inlets are connected with three intake sides of the housing. In one example embodiment, the housing has four sides and has an essentially rectangular basic shape. In this example embodiment, the external air enters the air conditioning system from three sides for the removal of heat. Preferably, these are an end face and the two longitudinal sides. In one example embodiment, the air inlets extend over almost the entire end face and project as close as possible to the end face on the longitudinal sides. In one example embodiment, the end face serves not only as the intake side, but also as the blow-out side.

One example embodiment provides that the housing has a plurality of air inlets and a plurality of air outlets, that the air inlets and the air outlets are located at different levels along a height of the air conditioning system, and that the level of the air inlets is above the level of the air outlets. In one example embodiment, the air inlets and air outlets considered herein with respect to the levels or planes are located on a common side of the housing, which is preferably a rear end face of the housing. The planes or levels should be understood as extending perpendicularly to a height of the air conditioning system here. This height profile results, for example, along the force of gravity in the installed state, so that, for example, one plane or level is higher than the other(s) relative to the bearing surface of the air conditioning system. The bearing surface is, for example, a roof of a travel trailer or a motorhome. The level of the air outlets is below the level of the air inlets here. In one example embodiment, the level of the air outlets is located as low as possible so that the external air is also expelled as close as possible to the roof or generally near the bearing surface of the air conditioning system.

One example embodiment consists in that the condenser heat exchanger has the shape of a capital letter “U”, and that the condenser fan is arranged within the U-shape. In this example embodiment, the condenser heat exchanger has a curved shape and comprises an inner area. In one example embodiment, the condenser fan is located in this inner area. In one example embodiment, the tip of the U faces the end face of the air conditioning system so that the two flanks of the U extend along the two longitudinal sides.

According to one example embodiment, pockets are located between the housing and the condenser heat exchanger, the pockets directing the external air towards the bottom of the U-shape of the condenser heat exchanger. This means that the pockets are larger cavities between the condenser heat exchanger and the internal structure of the housing. Or, in other words, there is room around the condenser heat exchanger for guiding external air. Here, the pockets in particular direct the external air towards the bottom of the U-shape, that is, towards that part of the letter U from which the two lateral legs branch off. The air guided to the base or tip (as alternative designations for bottom) of the U here is preferably the external air sucked in via the longitudinal sides. This also ensures that, as far as possible, no heated external air is returned to the air conditioning system. This applies, above all, in the context of the example embodiment in which the heated external air is blown out via the rear end face.

One example embodiment provides that the condenser heat exchanger is located downstream of the at least one air inlet, and that the condenser fan pulls the external air through the condenser heat exchanger. In one example embodiment, a plurality of air inlets are provided and the condenser heat exchanger extends along the air inlets and is preferably located behind the mouths of the air inlets.

In one example embodiment, only part of the structure of the air outlets is formed by the housing itself. The rest, and in particular the lower portions of the ducts of the air outlets, are formed in the installed state by the surface on which the air conditioning system is mounted. In this way, for example, a vehicle roof constitutes a boundary for the air outlets.

The following example embodiment relate to the evaporator side of the air conditioning system, i.e. that part of the air conditioning system in which the air to be cooled is cooled by interaction with the refrigerant.

One example embodiment consists in that the air conditioning system includes at least one housing and an evaporator heat exchanger, wherein the air to be cooled passes through the evaporator heat exchanger, wherein the evaporator heat exchanger is arranged on a bearing surface of the housing, and wherein the bearing surface includes at least two fins.

The evaporator heat exchanger is a part of the evaporator in which the thermal energy of the air to be cooled is transferred to the coolant. For this purpose, the air is passed through the evaporator heat exchanger. The evaporator heat exchanger is arranged in a housing, resting on a bearing surface. Insofar as the air conditioning system involved is a so-called roof-mounted air conditioning system, which means it is mounted on the roof of a travel trailer or a motorhome, for example, the bearing surface is located toward the roof and forms a part of the bottom of the air conditioning system, so to speak. The bearing surface does not have a flat or planar shape, but has several—at least two—fins on which the evaporator heat exchanger stands. An advantage of the fins is that they enhance cooling performance by preventing air from passing underneath the evaporator heat exchanger. Alternatively or complementarily, the fins cause such air to be directed into the evaporator heat exchanger from below. The fins thus increase the resistance for the air that could flow below the evaporator heat exchanger and/or act as components that guide the air. Furthermore, the interaction of the air with the evaporator heat exchanger causes drying of the air. The moisture thus removed from the air condenses and the condensed water collects below the evaporator heat exchanger. Here, the fins ensure that the condensed water drips down into the areas between the fins—that is, into the valleys. Moreover, the fins also provide the advantage that the undesirable air flowing along under the evaporator heat exchanger cannot absorb and carry off any condensed water, or only very little.

The following are thus configurations relating to the evaporator functionality.

One example embodiment consists in that the fins are formed in such a way as to direct air below the evaporator heat exchanger into the evaporator heat exchanger. In this example embodiment, the fins thus not only cause the resistance for the air below the evaporator heat exchanger to be increased, but they also selectively direct the air into the evaporator heat exchanger. The direction of movement of the air is thus deflected in a targeted manner. This is preferably possible by the shaping of those flanks of the fins against which the air stream flows. Furthermore, to this end, the evaporator heat exchanger is preferably designed to be open toward the bearing surface so that the air can flow into it from below.

One example embodiment provides that the housing and the bearing surface are formed and matched to each other such that alternatively at least two evaporator heat exchangers having different depths can be fixed in the housing. In this example embodiment, it is possible to use one housing for different variants of the air conditioning system. In this case, the air conditioning systems differ at least with respect to the evaporator heat exchangers, which have different depths and therefore also have different cooling capacities. The depth in this case is defined as the extension along the direction in which the air is passed through the evaporator heat exchanger. Therefore, a greater depth also allows a higher cooling capacity.

One example embodiment consists in that tubes for carrying a refrigerant are arranged in the evaporator heat exchanger, and in that the tubes are arranged in at least two rows. In order to produce as large an effective surface as possible, the refrigerant is passed through a tube structure. The tubes are arranged in several and at least two rows one above the other, so that a meandering course is obtained for the coolant in each case. In one example embodiment, the tubes of the individual rows are connected to each other at the sides of the evaporator heat exchanger for the coolant.

In one example embodiment, the rows of tubes are arranged one behind the other in the direction of the air passing through the evaporator heat exchanger, so that each row involves a further interaction with respect to the cooling of the air. As the number of rows of tubes arranged one behind the other increases, the depth of the evaporator heat exchanger also increases.

One example embodiment consists in that an evaporator heat exchanger having a maximum depth can be fixed in the bearing surface, in that a maximum number of rows of the tubes is assigned to the maximum depth, and in that the number of fins is at least equal to the maximum number of rows of the tubes. In this example embodiment, the housing is adapted to receive a type of evaporator heat exchanger having a maximum depth. Other types that are shorter can also be accommodated accordingly. Except for the depth, the dimensions of the different types of evaporator heat exchangers are therefore alike. The maximum depth is associated with a maximum number of rows of tubes. Here, the number of fins is at least equal to the maximum number of rows. This implies that each row has one fin associated with it. In one example embodiment, this causes each fin to deflect the air toward the associated row of tubes. In one configuration, the number of fins is exactly the same as the maximum number of rows.

In one example embodiment, the fins are substantially identical in design. This simplifies manufacturing. In an alternative example embodiment, the fins are of different design. Here, consideration is given to the fact that the amount of air to be deflected decreases from fin to fin along the general direction of flow.

One example embodiment provides that the fins are oriented substantially perpendicular to a direction of air flow through the evaporator heat exchanger. In this example embodiment, the upper edges of the fins extend perpendicularly to the flow-through direction. In one example embodiment, the fins have a triangular cross-section, with the lateral flanks being curved in one example embodiment.

One example embodiment is that the bearing surface serves as a collecting pan for condensed water. The condensed water forms on the evaporator heat exchanger and drips down by gravity and therefore onto the bearing surface, which in this example embodiment thus also serves as a collecting pan. For this purpose and for draining off the condensed water, corresponding recesses for draining off are provided in one example embodiment.

In a further example embodiment, a distributor structure is arranged upstream of the evaporator heat exchanger, the distributor structure substantially uniformly distributing the air to be cooled over a side of the evaporator heat exchanger.

The evaporator heat exchanger is part of the evaporator in which the thermal energy of the air to be cooled is transferred to the coolant, so that the cooling of the air is obtained. For this purpose, the air is guided through the evaporator heat exchanger. The air conditioning system is, for example, a so-called roof-mounted air conditioning system, which means that it is mounted on the roof of a travel trailer or motorhome, for example. In order to optimize the cooling capacity, a distributor structure is provided here, which distributes the air to be cooled as uniformly as possible over one side of the evaporator heat exchanger. The air to be cooled thus flows against this side, which is also the side facing the aforementioned distributor structure. By evenly distributing the air supplied, the interaction with the coolant that flows through the evaporator heat exchanger can thus also be optimized.

The further configurations relate to the distributor structure.

One example embodiment provides that the air conditioning system includes an evaporator fan, and that the evaporator fan is arranged opposite the distributor structure relative to the evaporator heat exchanger. In this example embodiment, an evaporator fan draws the air to be cooled through the evaporator heat exchanger. As a result, the air to be cooled first flows into the space between the distributor structure and the evaporator heat exchanger, passes through the evaporator heat exchanger, and then is directed through the evaporator fan. Or in other words, the evaporator heat exchanger is located between the distributor structure and the evaporator fan.

One example embodiment includes that the distributor structure has at least one bulge that rises toward the evaporator heat exchanger. In this example embodiment, the distributor structure is defined more specifically in that it has a kind of protrusion that extends toward the evaporator heat exchanger. This bulge or dent thus also reduces the distance from the evaporator heat exchanger. The distributor structure therefore approaches the evaporator heat exchanger in the region of the bulge, thus reducing the space for the air to be cooled in front of the evaporator heat exchanger. In one example embodiment, the bulge is a kind of wave the flanks of which extend toward the sides from which the air to be cooled is brought in. In one example embodiment, the bulge is symmetrical with respect to a center. In an alternative example embodiment, the bulge is formed to be asymmetrical. In one example embodiment, the air to be cooled flows into the space in front of the evaporator heat exchanger from two sides, and the bulge is located essentially between these two inflow sides.

One example embodiment provides that the bulge is configured and arranged in relation to the evaporator heat exchanger such that in a region of a maximum extent of the bulge, a distance between the bulge and the evaporator heat exchanger is at least 50% smaller than in other regions of the bulge. The bulge reduces the distance from the evaporator heat exchanger, through which the air to be cooled is passed. In this example embodiment, the distance is reduced to more than half in the region in front of the maximum extent. The maximum extent here is the tip or, depending on the configuration, the center of gravity of the bulge.

One example embodiment includes that the bulge is configured and arranged in relation to the evaporator heat exchanger such that a distance between the bulge and the evaporator heat exchanger decreases along a height profile of the evaporator heat exchanger. In this example embodiment, the bulge is configured and arranged along a height profile of the evaporator heat exchanger in such a way that the space in front of the evaporator heat exchanger narrows upward. Upward is understood here to mean away from the base surface of the air conditioning system. This is the base surface which in the installed state rests, for example, on a roof of a movable vehicle. The space into which the air to be cooled flows is therefore larger in the foot area of the evaporator heat exchanger than in the head area.

One example embodiment provides that the air conditioning system includes a housing, the evaporator heat exchanger is located within the housing, and the bulge is part of the housing. In this example embodiment, the housing is formed such that it includes the distributor structure.

One example embodiment includes that a maximum extent of the bulge is arranged within a projection of an effective area of the evaporator fan. In this configuration, the bulge is in the form of a kind of wave or dune, with the tip or, depending on the configuration, the center of gravity of this wave being located in the region along the effective area of the evaporator fan. Therefore, the smallest space for the air to be cooled is in front of the evaporator heat exchanger in the direction of movement upstream of the effective area of the evaporator fan.

### BRIEF DESCRIPTION OF DRAWINGS

More specifically, there is a multitude of possibilities for configuring and further developing the air conditioning system according to the invention. In this regard, the description below of exemplary embodiments in conjunction with the drawings, in which:

FIG. 1 shows a schematic illustration of an air conditioning unit;

FIG. 2a shows a section taken through a configuration of an air conditioning system;

FIG. 2b shows a view of a spatial illustration of the air conditioning system of FIG. 2a without part of the housing;

FIG. 3a shows an enlarged representation of the section of FIG. 2a in the area of the evaporator;

FIG. 3b shows a top view of the area of the evaporator;

FIG. 3c shows a section similar to FIG. 3a taken through an alternative configuration of the area of the evaporator;

FIG. 4 shows a top view of the bearing surface below the evaporator heat exchanger;

FIG. 5 shows part of a spatial illustration of the area of the evaporator;

FIG. 6 shows a view of the upper half of the housing of the air conditioning system;

FIG. 7 shows a view of the underside of the air conditioning system; and

FIG. 8 shows a view of the spatial illustration of the underside as well as the rear end face of the air conditioning system.

### DETAILED DESCRIPTION OF EXAMPLE EMBODIMENTS

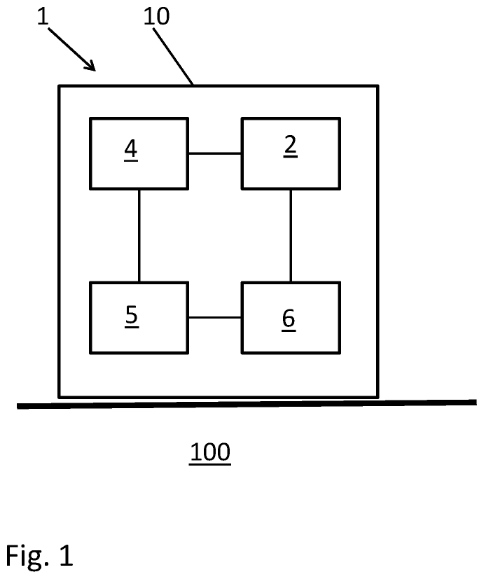

FIG. 1 schematically shows the structure of an air conditioning system 1 for cooling a room 100. The cooling circuit or refrigeration process implemented with it is described, for example, in WO 2007/042065 A1. The room 100 is, for example, the interior of a travel trailer or a motor home. For this case of application, the air conditioning system 1 is thus mounted on the vehicle roof of the travel trailer or motor home.

For the refrigeration process, a compressor 2 compresses a gaseous refrigerant, which thus absorbs heat and is conveyed to a condenser 4 through a refrigerant pipe.

In the condenser 4, the heat of the refrigerant is released to the ambient air (or external air) from the environment around the room 100. In this process, the external air is taken in by means of a condenser fan 40 and, after interaction with the refrigerant, is blown out again in a condenser heat exchanger 41. As a result of the release of heat, the compressed refrigerant will condense.

The liquid refrigerant, which continues to be under high pressure, is expanded to a lower pressure in an expansion device 5, which is in the form of a restrictor, for example. In the process, the refrigerant cools down.

In the next step, the refrigerant reaches an evaporator 6, through which the air of the room 100 to be cooled is passed by means of an evaporator fan 60. In the process, the air transfers its heat to the refrigerant, which transitions to the gaseous state. The gaseous refrigerant eventually reaches the compressor 2 again, so that the cooling cycle can be continued.

The circuit can also be reversed so that the device 1 serves as a space heater.

The components described of the air conditioning system 1 are located in a housing 10 which—as shown, for example, in WO 2007/042065 A1—is comprised of two shells, depending on the embodiment. Here, the housing 10 and the components are also configured and matched to one another such that the housing serves to fasten the components of the air conditioning system 10 by an interlocking fit.

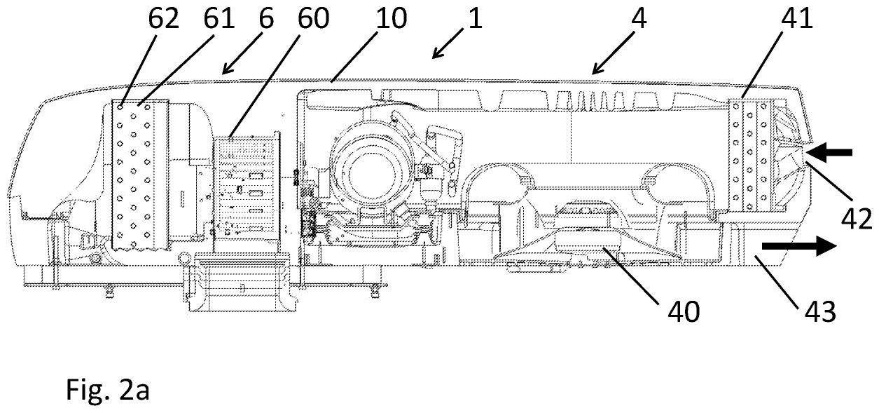

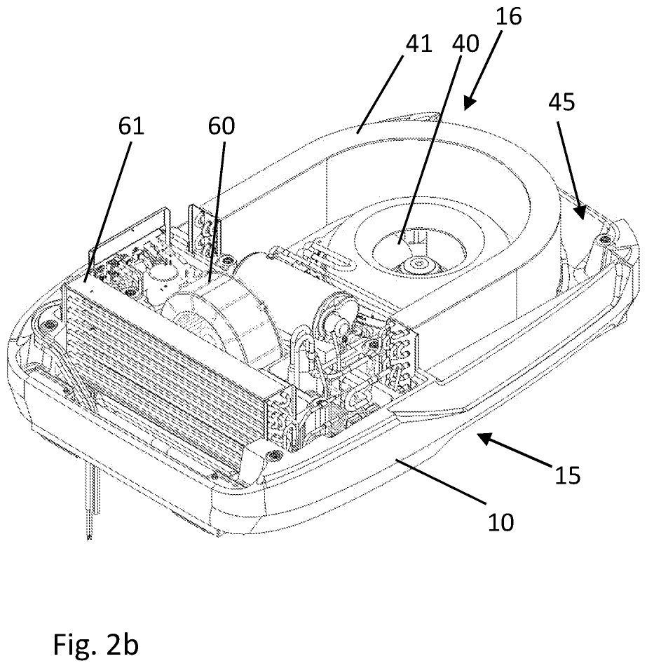

FIG. 2a illustrates a sectional view along a longitudinal axis through a configuration of an air conditioning system 1. The end faces of the air conditioning system 1 are thus shown here on the right and left, with the end face on the left here facing the direction of travel and the end face 16 on the right facing away from the direction of travel in the installed state. This refers to the case where the air conditioning system 1 is mounted on the roof of a movable vehicle, such as, for example, a travel trailer or motorhome.

The air conditioning system 1 has two heat exchangers 41, 61 and two fans 40, 60. The fans 40, 60—in the functional portions of the condenser 4 and the evaporator 6, respectively—each cause air to be directed through the heat exchangers 41, 62 and to be heated or cooled in the process. In the following, the configurations of the two associated areas of the air conditioning system 1 (i.e., evaporator 6 as well as condenser 4) are described in detail and each also in reference to FIG. 2a.

In this context, one heat exchanger 61 may also be referred to as an inner or internal heat exchanger, since it cools the inner air, that is, the air, to be cooled, of the room 100. This heat exchanger 61 thus interacts with the inner air. The other heat exchanger 41 is used to interact with the external air by transferring the heat of the refrigerant to the external air. Therefore, this heat exchanger 41 may also be referred to as an outer or external heat exchanger.

The exemplary air conditioning system 1 of FIG. 2a is a so-called roof-mounted air conditioning system, in which the main components are arranged on the roof of the room 100 the air of which is to be cooled. In the ceiling—not illustrated here—there is a passage through which the air enters the air conditioning system 1 and is blown out again from there—as cooled air. Below the ceiling there is then usually also a so-called air distributor for distributing the cooled air in the interior 100.

The air conditioning system 1 not only effectuates cooling of the indoor air, but also drying. In the process, the moisture in the air accumulates as condensed water (an alternatively used term is condensate) and collects in particular at the evaporator heat exchanger 61.

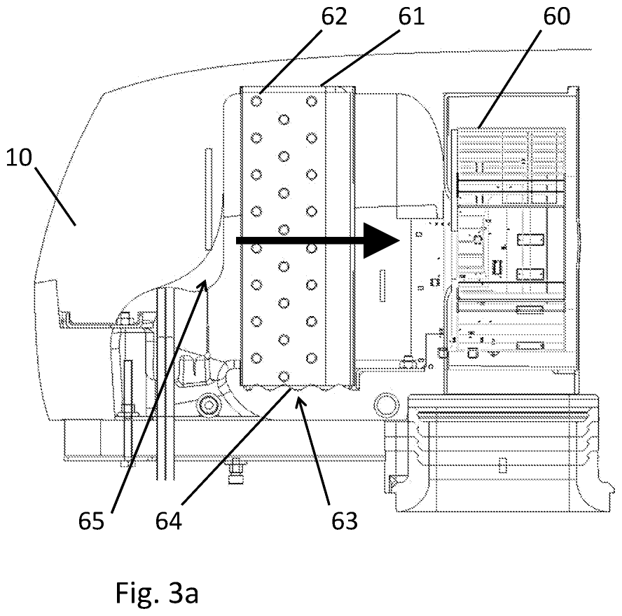

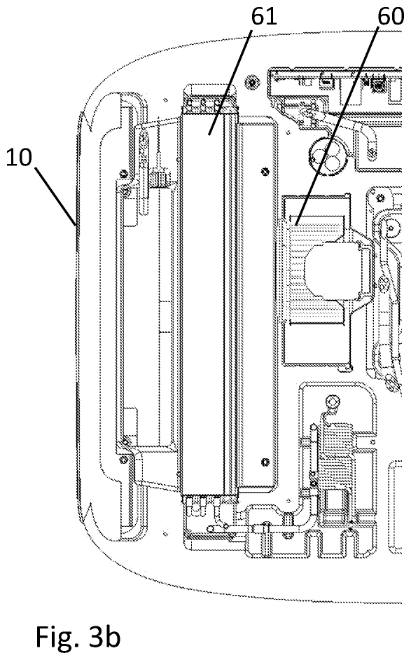

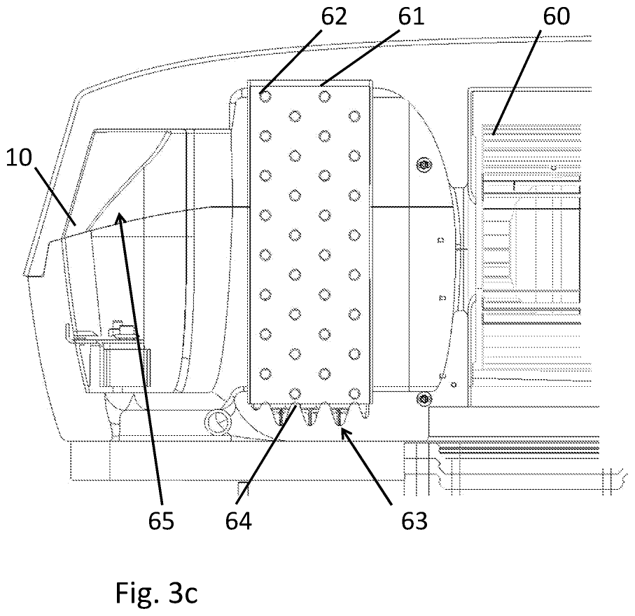

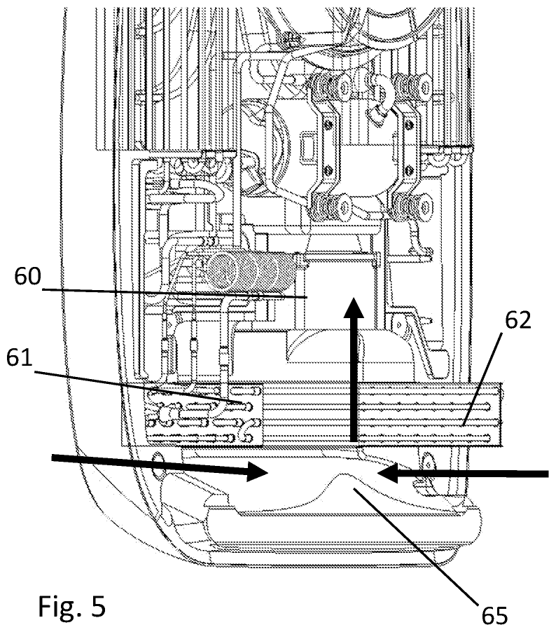

The evaporator heat exchanger 61 shown in FIG. 2a has three rows of tubes 62, through which the refrigerant is passed. In section, the tubes 62 appear as circles. This can also be seen in the enlarged view of FIG. 3a. The spatial representation of the tubes is given, for example, in FIG. 5, which also shows how the individual tubes 62 for the refrigerant are connected to each other at the end faces of the evaporator heat exchanger 61.

Depending on the maximum cooling capacity, different numbers of rows of tubes 62 are provided. It can be seen in FIG. 2a, for example, that there would be room on the right-hand side for another row of tubes 62 or an evaporator heat exchanger 61 of greater depth. In the variant of the air conditioning system 1 of FIG. 3c, this free space is filled by the evaporator heat exchanger 61 having four rows of tubes 62. The space in the housing 10 thus allows the insertion of evaporator heat exchangers 61 of different depths.

The evaporator heat exchanger 61 stands upright in the housing 10 and the condensed water drips down by the force of gravity. At the base of the evaporator heat exchanger 61, the condensed water is then drained off using suitable geometries—not illustrated here—or, for example, by a pump.

FIGS. 3a and 3b show, on an enlarged scale, the area around the evaporator heat exchanger 61 of a first configuration and FIG. 3c of a second configuration. FIG. 3a and FIG. 3c each show a lateral section, and FIG. 3b shows a top view of the area shown in FIG. 3a.

The evaporator heat exchanger 61 is clamped in the housing 10 from above and below, and is thereby held in position by the housing 10. An identical enclosure—as can be seen in particular in FIG. 3b—is provided on the end faces of the evaporator heat exchanger 61, that is, along the axis perpendicular to which the section runs here. This fixing by an interlocking fit between components and the housing 10 is shown, for example, in WO 2007/042065 A1 already cited.

FIG. 2b, for example, also shows that the evaporator heat exchanger 61 is held in place by the structures of the housing 10 itself. In this FIG. 2b it can also be seen that the evaporator fan 60 is also held in position by the housing 10 itself.

The (indoor) air to be cooled is moved from left to right—as indicated by the arrow in FIG. 3a—toward the evaporator fan 60 through the evaporator heat exchanger 61. See also the middle arrow in FIG. 5.

In order to prevent, as far as possible, the condensed water from being entrained by the cooled air, the bearing surface 63 in the housing 10 below the evaporator heat exchanger 61 is specially shaped here (see FIG. 3a and FIG. 3c). Furthermore, this shaping of the bearing surface 63 is intended to prevent air from flowing through beneath the evaporator heat exchanger 61 and thus not being cooled.

As can be seen, this does not involve a flat or planar bearing surface 63, but rather there are individual fins 64 which extend below and along the lower side of the evaporator heat exchanger 61. Located between the fins 64 are valleys in which condensed water can collect and flow off toward drainage openings not shown here. The height of the fins 64 or, correspondingly, the depth of the valleys, which thus serve as collecting pans for the condensed water, determines the amount of condensed water that can be collected. Draining from the valleys occurs, for example, by the action of gravity or by the action of, for example, a pump—also not shown here. As can be seen clearly in FIG. 3a and FIG. 3c, the lower outer edges of the evaporator heat exchanger 61 abut the outer fins and are therefore encompassed laterally by the housing 10.

The fin structure prevents air from incorrectly passing underneath the evaporator heat exchanger 61 on the side of the air inlet (on the left in each of FIGS. 3a and 3c) into the evaporator heat exchanger 61. On the side on which the cooled air leaves the evaporator heat exchanger 61, a further blockage is produced for the air or the condensed water.

Furthermore, the fin structure deflects air that might still have moved to below the evaporator heat exchanger 61 in different directions again and again (up and down along the fins 64). This reduces or prevents air from flowing underneath the evaporator heat exchanger 61 and also has the effect of preventing condensed water from being entrained.

In this regard, the numbers and positions of the fins 64 in the illustrated variant are configured such that one fin 64 is located below each row of tubes 62. Each fin 64 directs the air back into the evaporator heat exchanger 61 and at the same time increases the resistance for the air flowing beneath the evaporator heat exchanger 61 and thus misdirected. If the condensed water drips down, it is carried toward the valleys, each of which is adjacent to a fin 64. Here there are four fins 64, so that an evaporator heat exchanger 61 having four rows of tubes 62 may also be received in the free space (see FIG. 3a) on the right side. This can be seen in FIG. 3c. In the variant of FIG. 3a, thus, an additional fin 64 is provided.

The condensed water thus drips downward and collects in the valleys between the fins 64 of the bearing surface 63. Since the evaporator heat exchanger 61 stands on the fins 64, the condensed water can therefore not, or only to a very small extent, be entrained from a respective valley toward the evaporator fan 60 by the air flow.

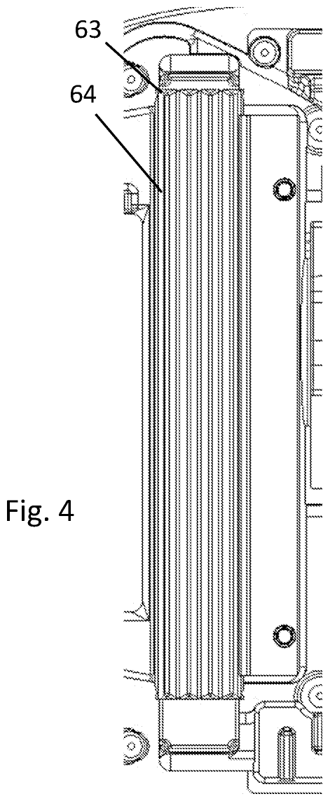

FIG. 4 shows a top view of the bearing surface 63 with the four fins 64, between which the valleys for collecting the condensed water are located. The bearing surface 63 has a rectangular basic shape, which matches the rectangular footprint of the evaporator heat exchanger 61.

FIG. 3a and FIG. 3c show a bulge 65 projecting into the space in front of the evaporator heat exchanger 61 in the housing 10 on the left side of the drawing. This bulge 65 can also be seen in FIG. 2a and FIG. 5 to FIG. 7. This bulge 65 is part of the correspondingly shaped housing 10, which has been, for example, injection-molded and/or cast accordingly.

The bulge 65—protruding out toward the side of the evaporator heat exchanger 61 against which the air flows—projects into the space into which the indoor air to be cooled is guided to pass through the evaporator heat exchanger 61 (see the arrow in FIG. 3a and the middle arrow in FIG. 5).

As indicated in FIG. 5 by the two horizontally running arrows, the air enters laterally (that is, from the right and left) into the area in front of the evaporator heat exchanger 61 and moves from there toward the evaporator fan 60. Here, the bulge 65 is shaped similar to a wave crest or dune, so that the air is guided into the area in front of the tip of the bulge 65 by the smoothly extending sides.

It is further apparent from FIG. 5 that the bulge 65 is slightly asymmetrical and therefore has two differently pronounced flanks. The lateral air flows are directed toward the evaporator heat exchanger 61 by the bulge 65. The center of gravity or the tip of the bulge 65 as its maximum extent in the direction of the evaporator heat exchanger 61 is located at the level of the evaporator fan 60 here, which itself is offset with respect to a longitudinal axis of the air conditioning system 1.

The bulge 65 produces a partial narrowing of the space in front of the evaporator heat exchanger 61. The air enters this space from each side, so that on each of these two sides there is also the largest space between the bulge 65 as a distributor structure and the evaporator heat exchanger 61. The outer contour of the side of the evaporator heat exchanger 61 facing the bulge 65 is essentially given by a flat rectangular shape.

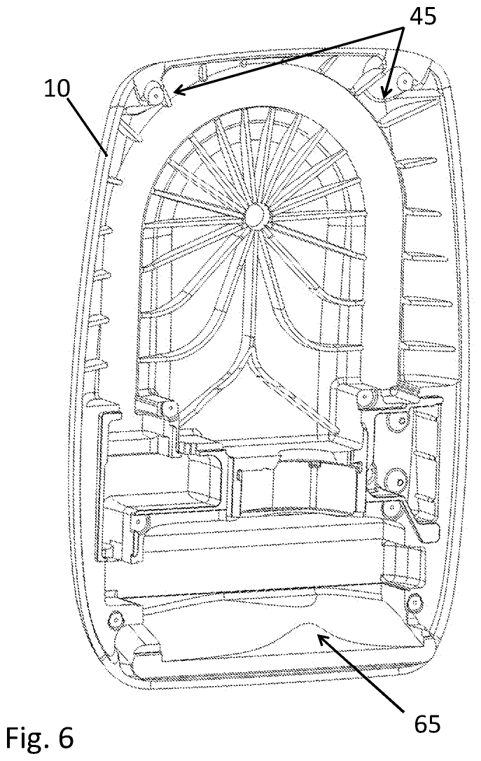

The position of the bulge 65 relative to the evaporator fan 60 can be seen, for example, with the aid of the inside of the upper half of the housing of FIG. 6. Here, the distributor structure 65 is located at the bottom of the drawing. Above the maximum extent of the bulge 65, there is first the recess for the evaporator heat exchanger 61, which is rectangular in a plan view, and above it—and offset to the right from the center here in the drawing—the recess for the evaporator fan 60. The bulge 65 thus rises into the projected area (or in front of the elongation downward) in front of the position of the evaporator fan 60 (see, e.g., FIG. 5). However, the center of gravity (or the tip) of the bulge 65 is not disposed along the centerline of the evaporator fan 60, but is slightly offset in relation thereto.

As can be seen in FIG. 3a, FIG. 3c as well as FIG. 6, the bulge 65 also extends with a special shape along the height of the housing 65 or along the height of the evaporator heat exchanger 61.

The profile of the bulge 65—here viewed along the height of the housing 10 and therefore in the installed state also along the earth's gravitational pull—first constricts the upper space in front of the evaporator heat exchanger 61 to a very narrow area and then widens the area in a type of S-shape. The space in front of the lower part of the evaporator heat exchanger 61 is thus significantly larger and wider than the space in front of the upper part. The constriction in the upper area in the space in front of the evaporator heat exchanger 61 forces the air flowing in from the sides downward, as it were.

This shape of the bulge 65, which differs laterally and in its height profile, can be seen clearly in FIG. 6 in particular. The distributor structure 65 thus constricts the space in front of that side of the evaporator heat exchanger 61 against which the air flows not only from the two sides (right and left) toward the middle, but also from the bottom upward (in each case starting from the installed state and thus preferably relative to the vehicle roof on which the air conditioning system 1 is mounted). The largest volume thus exists on the right and left sides and at the bottom in the direction of the earth's field or in the direction of the vehicle roof, if the air conditioning system 1 has been mounted on a roof, for example.

The bulge 65 provides for a uniform velocity distribution of the air in front of the evaporator heat exchanger 61 and in this way improves the cooling behavior thereof, since there is a uniform flow through it. Another advantage is that the air volume is uniformly distributed and therefore the air flows uniformly through the evaporator heat exchanger 61 as well. This also improves the cooling performance. The air to be cooled is thus fanned out and distributed as far as possible over the entire side of the evaporator heat exchanger 61.

In FIG. 2a (here on the right-hand side in the drawing), that part of the air conditioning system 1 can be seen into which external air is sucked, passed through a condenser heat exchanger 41 and blown out again into the exterior space around the room to be cooled. In the process, the heat extracted from the indoor air is transferred to the exterior air. The condenser fan 40 is used for suction and blowing out.

It is apparent from FIG. 2b that the condenser fan 40 and the condenser heat exchanger 41 are located in the region of the rear end face 16 of the housing 10. Between the two end faces 16 there are the longitudinal sides 15, of which only one can be seen in FIG. 2b.

In FIG. 2b, the special shape of the condenser heat exchanger 41 can further be seen. This is the shape of a capital letter “U” or, as an alternative designation, a horseshoe shape. The condenser fan 40 is thus completely surrounded by the condenser heat exchanger 41 except for the opening of the “U”. The condenser fan 40 is located toward the closed end of the U-shape. The condenser fan 40 moves the air into the plane below the condenser heat exchanger 41 and thus—as a result of the guiding by the structure of the air outlets 43—also toward the closed end of the U-shape. The condenser heat exchanger 41 is thus also located above the plane in which the heated exterior air is transported out of the air conditioning system 1. The closed end of the U-shaped condenser heat exchanger 41 is thus arranged toward the end face 16 or the blow-out side 11. Or, in other words, the U-shape is open toward the interior of the housing 10 or the air conditioning system 1. Here, the opening of the U faces the interior of the air conditioning system 1. This means that the area over which the external air can move through the condenser heat exchanger 41 to the condenser fan 40 and out of the air conditioning system 1 again via this fan is as large as possible. The closed side of the U-shape

Furthermore, FIG. 2b shows that the condenser heat exchanger 41 has a greater distance from the two side flanks of the housing 10, which finally opens out at the rear end face 16 of the housing 10 into pockets 45, of which only one can be seen here. In these pockets 45, the external air flowing in from the longitudinal sides 15 is increasingly redirected towards the closed end of the U-shape of the condenser heat exchanger 41. This also contributes to the fact that most of the external air originates from the longitudinal sides 15 of the housing 10. This further reduces the potential proportion of heated external air sucked in.

In one configuration—not shown here—there is no opening for the intake of external air at the rear end face 16, but only for the ejection of the external air that has passed through the condenser heat exchanger 41.

The shape of the pockets 45 is apparent from the upper side of the housing 10, which is shown in FIG. 6.

At the upper end in the drawing here, which is the rear end face, the U-shaped profile of the condenser heat exchanger 41 and the space around it can be seen. The substantially rectangular shape of the housing 10 results in the pockets 45 around the bottom of the capital letter U of the condenser heat exchanger 41. The fins extend between the air intakes on the two longitudinal sides.

In FIG. 2a, the two arrows indicate that the intake area—along the axis of the earth or, in the installed state, away from the vehicle roof—is located above the ejection area. The heated air is thus blown out near the vehicle roof. This causes the air to have a higher velocity and to be moved sufficiently far away from the intake openings 42. This provides the advantage that, as far as possible, only the normally tempered external air is sucked in, rather than the air that has already been heated by the air conditioning system 1. This enhances the effectiveness of the air conditioning system 1, since in this way, more heat can be transported away.

It is further apparent from FIG. 2a that the condenser heat exchanger 41 is substantially directly adjoining the air inlet 42 in the housing 10. Thus, the ambient air is drawn through the condenser heat exchanger 41 by the condenser fan 40. After heat transfer, the warmer air flows through the condenser fan 41 and then back into the environment.

Altogether, the external air flows into the air conditioning system 1 from a position further away from the vehicle roof, passes through the condenser heat exchanger 41, and is then deflected to a lower position and blown out through the air outlet 43 in the vicinity of the vehicle roof.

In FIG. 2a, only the rear air inlet 42 and the air outlet 43 located below it can be seen, with the inlet 42 and the outlet 43 being located one above the other and at the rear end of the housing 10. When mounted on a vehicle roof, the end face 16 of the housing 10 or of the air conditioning system 1 is generally arranged opposite to the direction of travel. It can also be seen that the condenser heat exchanger 41 has three rows of tubes.

It can be seen in FIG. 2a that an air inlet 42 for the ambient air is located at the end face 16 of the air conditioning system 1 opposite to the direction of travel. In particular, the condenser heat exchanger 41 is also located at this rear end face 16. This end face 16 serves at the same time as—in particular the only—blow-out side 11 for blowing out the heated external air and as the intake side 12 for the external air.

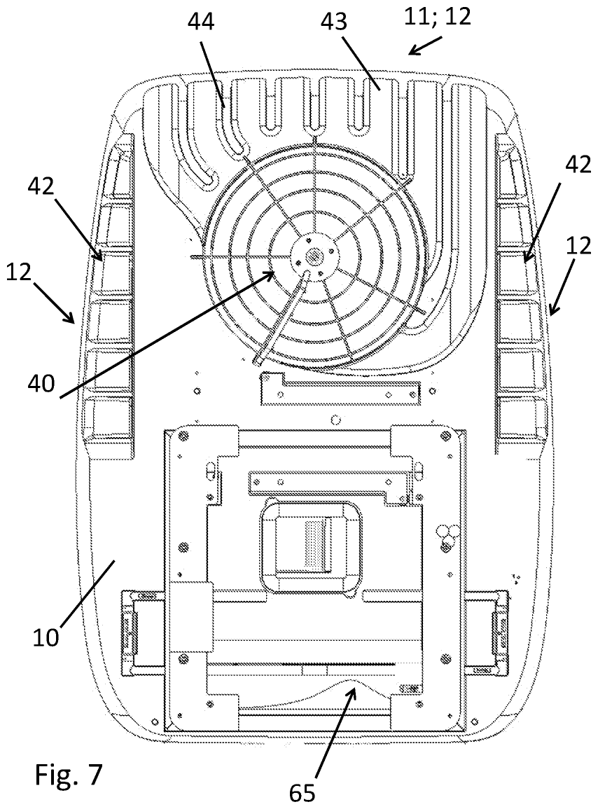

In FIG. 7, the rear end face 16 is located at the top of the drawing. FIG. 7 shows the underside of the air conditioning system 1 and thus the side that rests on the vehicle roof in the installed state.

In the upper area—or rear area in the installed state—the fan carrier for the condenser fan 40 can be seen. Further air inlets 42 are located along the two longitudinal sides 15, which thus serve as intake sides 12 for the external air. In total, the air conditioning system 1 has air inlets 42 for the external air in its area facing away from the direction of travel on all three outer sides, which can thus be referred to as intake sides 12. The air inlets 42 (of which the individual ducts are visible in the view of FIG. 7) on the longitudinal sides 15 here extend very close to the upper end face 16 of the air conditioning system 1. Therefore, the external air flows from three sides almost completely through the condenser heat exchanger 41.

The heated air is blown out only through the end face 16—the upper end face in the drawing in FIG. 7—of the air conditioning system 1, more specifically near the vehicle roof, and thus lower than the layer of the ambient air taken in.

In the illustrated configuration, eight air outlets 43 are provided, between which carrier components 44 are located. The condenser heat exchanger 41 rests on these carrier components 44 (see FIG. 2a). The carrier components 44 thus constitute both the boundaries of the air outlets 43 and the holding structure for the condenser heat exchanger 41. This contributes to the compactness of the air conditioning system 1 and allows the raised arrangement of the condenser heat exchanger 41 relative to the air outlets 43. Furthermore, the carrier components 44 allow the narrowing of the air outlets 43 so that a reaching-in can be prevented. Reaching in is dangerous in particular because it would otherwise be possible to reach as far as the condenser fan 40.

As can be seen in FIG. 7, the respective end portions of the air outlets 43 extend in a tubular shape and parallel to each other. This prevents swirling and ensures that the air continues to move in as straight a line as possible after leaving the air outlets 43. This generally serves the purpose of guiding the heated air away from the air conditioning system in as undisturbed a manner as possible, and therefore as far away as possible. This increases the expulsion distance of the air.

The underside of the housing 10 illustrated in FIG. 7 here forms only a part of the ducts of the air outlets 43, via which the air is conducted to the outside. In the assembled state, the bottom of these ducts forms the vehicle roof itself, on which the air conditioning system 1 is mounted.

The air outlets 43 branch off with wide initial portions from the circular condenser fan 40, and then, after a portion which is as large and elongated as possible, open into the aforementioned tubular end portions. It can be seen that the air outlets 43 have a generally vortex-like shape. Alternatively, at least the inner portion around the condenser fan 40 may also be understood as having the shape of a snail shell. In this case, the air outlet 43 located on the right here has the longest extent. Here, the structure depends on the direction of rotation of the condenser fan 40.

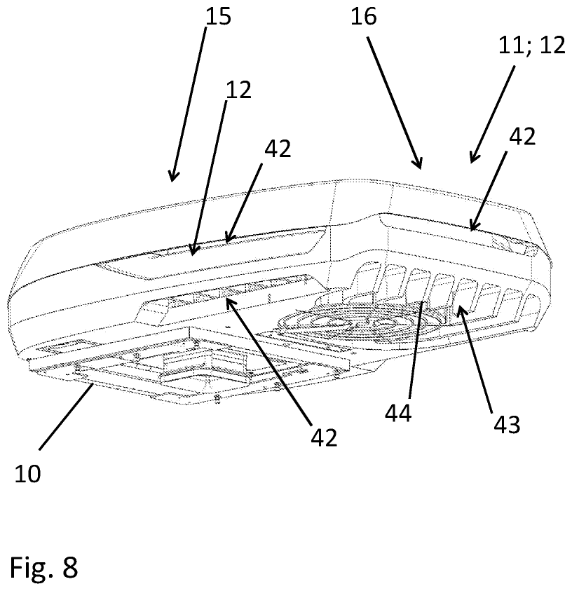

In FIG. 8, it can also be seen that the external air is sucked in from three intake sides 12 of the housing 10 and is discharged only into one blow-out side 11. Accordingly, the air inlets 42 can be seen here on two sides (longitudinal side 15 and rear end face 16) and an air outlet 43 can be seen on only one side (rear end face 16). The air outlet 43 is located on that blow-out side 11 which, when installed on a vehicle roof, e.g. of a travel trailer or a motorhome, is located contrary to the direction of travel. The external air heated by the interaction with the condenser heat exchanger 41 is therefore further entrained by the headwind while the vehicle is moving. Here, the air inlets 42 on the longitudinal sides 15 consist of the individual shafts and a large slot-like opening thereabove. The single slot of the air inlet 42 at the rear end face 16 is narrower than the two lateral slots on the longitudinal sides 15.

It is also readily visible on this end face 16 of the housing 10—which is the rear end face in the installed state—how the eight air outlets 43 open out in a straight line and parallel to each other, so that the expelled and heated external air is blown away as far as possible. The air is thus blown out each in the same direction.

The web-shaped carrier components 44 are located between the air outlets 43. The carrier components 44 bring about the further advantage that persons are prevented from reaching into the air outlets 43.

FIG. 8 also shows that the air outlets 43 are open at the bottom. This bottom of the air outlets 43 materializes only in the assembled state by means of the bearing surface, which is preferably a vehicle roof of a travel trailer or motor home. To this end, the carrier components 44 have a sufficient depth so that they rest on the bearing surface after assembly.

1. An air conditioning system for cooling of air, comprising: a condenser heat exchanger;
a condenser fan; and
a housing,
wherein the condenser heat exchanger transfers thermal energy of the air to be cooled to an external air,
wherein the housing includes at least one air inlet and a plurality of air outlets for the external air,
wherein the air outlets open only on a blow-out side of the housing,
wherein the condenser fan introduces the external air into the housing via the air inlet and discharges the external air via the air outlets,
wherein the air outlets are configured such that the external air continues to move in as straight a line as possible after leaving the air outlets, in order to avoid swirling, and
wherein the air outlets open in a straight line and parallel to each other so that the air streams flowing through the air outlets are each directed parallel to each other and away from the housing.

2. The air conditioning system according to claim 1,
wherein carrier components of the housing are located between the air outlets, and
wherein the carrier components carry the condenser heat exchanger, so that the carrier components constitute boundaries of the air outlets and a holding structure for the condenser heat exchanger.

3. The air conditioning system according to claim 2,
wherein carrier components of the housing are located between the air outlets, and
wherein the carrier components carry the condenser heat exchanger, so that the carrier components constitute boundaries of the air outlets and a holding structure for the condenser heat exchanger.

4. The air conditioning system according to claim 3,
wherein the housing has a plurality of air inlets,
wherein the air inlets are connected with three intake sides of the housing,
wherein the air inlets and the air outlets are located at different levels of a height of the air conditioning system, and
wherein the level of the air inlets is above the level of the air outlets.

5. (canceled)

6. (canceled)

7. (canceled)

8. (canceled)
